(19) United States
(12) Patent Application Publication
(10) Pub. No.: US 2025/0070701 A1
(43) Pub. Date: Feb. 27, 2025

(54) METHOD FOR DETERMINING A SET TORQUE FOR A MOTOR ALLOWING THE CONSUMED DC CURRENT TO BE CONTROLLED

(71) Applicant: JTEKT EUROPE, Irigny (FR)

(72) Inventor: Arnaud BOUCHET, Oullins (FR)

(73) Assignee: JTEKT EUROPE, Irigny (FR)

(21) Appl. No.: 18/811,898

(22) Filed: Aug. 22, 2024

(30) Foreign Application Priority Data
Aug. 24, 2023 (FR) 23/08913

(51) Int. Cl. H02P 21/22; B62D 5/04; H02P 21/18; H02P 21/20; H02P 27/06

(52) U.S. Cl. CPC H02P 21/22; B62D 5/046; H02P 21/18; H02P 21/20; H02P 27/06

(57) ABSTRACT

A method for determining a parameter representative of a set torque for a motor including: a regulation step determining a command variable as a function of a DC current threshold and a measured DC current; a determination step determining an upper limit and a lower limit of the parameter representative of the set torque as a function of the command variable; an evaluation step determining the parameter representative of the set torque as a function of the upper limit and the lower limit of the parameter representative of the set torque, and of a parameter representative of the desired torque.

The invention relates to the field of electric motors and more particularly to a method for determining a parameter representative of a set torque for an electric motor.

The invention applies to an electric motor and more particularly to a brushless electric motor, driven by a vector control method, independently of a number of phases or windings. Said electric motor receives an AC supply current from an inverter driven by the vector control method, said inverter being supplied with a DC supply current.

Hereinafter, the DC supply current will be referred to as direct current (DC current) and the AC supply current will be referred to as alternating current (AC current).

Hereinafter, a system upstream of the inverter which is responsible for providing or recovering the DC current from the inverter is called a DC supply system, or a DC system. For example, said upstream system may be a battery or a DC-DC converter.

The inverter transforms the DC current into AC current which supplies the motor.

Vector control, also called field-oriented control, is a known control method for electric motors in which the motor AC current is decomposed into two orthogonal components one along an axis q, hereinafter called quadrature axis current, denoted Iq, and the other along an axis d, is called direct axis current, denoted Id. The quadrature axis current Iq and the direct axis current Id are spatial currents of so-called direct magnetization axis denoted d, and of quadrature axis denoted q. The quadrature axis current Iq and the direct axis current Id correspond to a spatial projection of the three-phase current system on a rotating reference frame related to a rotor of the electric motor. The quadrature axis current Iq and the direct axis current Id are therefore a function of the phase shift of the three-phase current system with respect to the direct axis d and the amplitude of the three-phase system. For low reluctance motors, the direct axis current Id generally enables a reduction in a perceived magnetic flux to optimize a high-speed operation, while the quadrature axis current Iq controls a torque exerted by the motor, hereinafter called motor torque. The direct axis current Id and the quadrature axis current Iq are for example determined as a function of an operating point of the motor which is characterized by at least one parameter from among: a set torque, a rotational speed of the motor, a temperature of the motor, or a voltage of the motor AC supply current.

The motor is supplied with AC, comprising a direct axis component Id, and a quadrature axis component Iq, provided by the inverter.

The invention applies preferably in the field of power steering for a vehicle in which car manufacturers are seeking to control with increasing precision the power consumption of said power steering system, that is to say the DC supply current.

The object of a steering system of a vehicle is to enable a driver to control a vehicle path by modifying an angle of orientation of the vehicle's wheels by means of a steering wheel. The power consumption of the electric power steering system is difficult to predict as it depends on the forces transmitted by the wheels (parking maneuvers, driving, low grip, etc.) and the driver's desire to turn the steering wheel. The electric power steering system, however, has the capacity and predisposition to generate very high-power consumption.

There are different solutions making it possible to control the power consumption of the power steering system. Some are based on controlling the motor supply voltages at the AC current level, others on the motor torque or the quadrature axis current Iq.

Solutions based on a motor torque control or on the quadrature axis current Iq have the advantage of maintaining control of the set torque, which is not possible with an action on the motor supply voltages. However, this control involves complex designs and developments to guarantee performance and stability over all the operating ranges (temperature, speed, etc.) since the consumed DC current is dependent on multiple inputs including the motor torque (which is controlled), the voltage of the inverter DC supply current, a motor rotational speed and to a lesser extent a variation of some parameters related to production and/or temperature and/or aging. By production it should be understood a use and/or manufacture of the motor. Indeed, some parameters such as electrical resistance of the motor winding, magnetic flux are dispersive during manufacture from one motor to another under the same environmental conditions but these parameters also vary with temperature.

The invention aims to remedy all or part of the aforementioned drawbacks by determining a parameter representative of a set torque of the motor making it possible to ensure compliance with a constraint on the consumed DC current.

The object of the invention is a method for determining a parameter representative of a set torque for a motor, said motor being supplied with AC current coming from at least one inverter, the at least one inverter being driven by at least one microcontroller using a vector control method, the at least one inverter being supplied with DC current coming from at least one DC supply system, the method being executed by the at least one microcontroller and comprising:
A control step in which a control parameter is determined at least as a function of a DC current threshold, a measured DC current and a limiting parameter;
A regulation step in which a command variable is determined at least as a function of the DC current threshold and the measured DC current;
A determination step in which an upper limit and a lower limit of the parameter representative of the set torque are determined at least as a function of the command variable;
An evaluation step in which the parameter representative of the set torque is determined at least as a function of the upper limit and the lower limit of the parameter representative of the set torque and a parameter representative of the desired torque.

The set torque is the torque that the motor must exert. The set torque is processed within the microcontroller so as to determine a direct axis and quadrature axis current allowing the motor to provide the set torque. In normal operation, the set torque substantially corresponds to the torque that the motor exerts, that is to say the motor torque.

The motor torque is the torque actually exerted by the motor. The motor torque depends on the motor AC supply current. A motor user wants the motor torque to be close to or equal to the set torque.

Hereinafter, all the elements making it possible to control the electric motor are called motor system. The motor system includes in particular the motor-inverter assembly and the microcontroller.

The electric motor according to the invention is supplied with AC current which is provided by the inverter. The inverter is itself electrically supplied with DC current.

The motor AC supply current is determined based on the parameter representative of the set torque determined by the method according to the invention.

The method comprises a regulation step performed by the microcontroller. During this step, a command variable is determined as a function of the DC current threshold and the measured DC current.

The DC current threshold is the maximum value of consumed DC current that we wish not to exceed. In other words, during motor operation, the DC current threshold corresponds to the DC current regulation value. The DC current threshold is determined by a user.

The measured DC current corresponds to the value of the DC current actually consumed by the motor during the previous iteration. The method according to the invention regulates the measured DC current so as to maintain it less than or equal to the DC current threshold. The command variable corresponds to a virtual command DC current making it possible to maintain the maximum value of consumed DC current less than or equal to the DC current threshold.

The regulation step makes it possible to compensate on the one hand for parametric variations, in particular for the flux and the motor resistance whose values change as a function of the temperature and in production with respect to a reference value implemented in the control, and on the other hand for dynamics in that lower-level regulation loops can generate a certain delay in the control of the desired torque.

The limiting parameter comprises an active and inactive state indicating that a limitation of the parameter representative of the set torque is performed during the evaluation step. The state of the limiting parameter is therefore determined during the evaluation step.

During the control step, the microcontroller activates or deactivates performance of the regulation of the measured DC current according to a value assumed by the control parameter. In other words, it makes it possible to implement the regulation step according to some conditions. For this, a control parameter is passed into an active state or an inactive state depending on at least the DC current threshold, the measured DC current and the limiting parameter. The control step, via the limiting parameter, makes it possible to continuously regulate the parameter representative of the set torque. The method regulates the measured DC current when the set torque is exceeded or limited. In other words, the regulation and determination steps are only carried out when the measured DC current is greater than or equal to the DC current threshold and until the limiting parameter indicates an inactive limitation.

The method comprises the determination step. During this step, an upper limit and a lower limit of the parameter representative of the set torque are determined at least as a function of the command variable. The determination step therefore follows the regulation step.

The upper limit and the lower limit define a value range in which the parameter representative of the set torque must be to ensure that the DC current measured or consumed by the motor remains less than or equal to the DC current threshold.

Since the dispersion of the physical parameters of the motor system is taken into account by the command variable, this step does not implement calculations or an adjustment of complex variables.

The method finally comprises the evaluation step. During this step, the parameter representative of the set torque is determined at least as a function of the upper limit and the lower limit of the parameter representative of the set torque and a parameter representative of the desired torque.

The desired torque is the torque that the user would like the motor to exert regardless of the consumed DC current. The desired torque is determined by a high-level controller. In the case of a power steering system, the desired torque is determined in particular based on a steering wheel torque exerted by a driver on a steering wheel.

The parameter representative of the set torque must therefore be as close as possible to the parameter representative of the desired torque while respecting the value range determined by the upper and lower limits. The evaluation step can therefore perform a limitation of the parameter representative of the set torque by the upper and lower limits.

According to one embodiment, the evaluation step determines the limiting parameter at least as a function of the parameter representative of the set torque and the parameter representative of the desired torque.

The limiting parameter indicates whether a limitation of the parameter representative of the desired torque was carried out during the evaluation step.

The regulation and determination steps are carried out only when the measured DC current is greater than or equal to the DC current threshold or when the regulation loop limits the set torque, which is indicated by the state of the limiting parameter.

According to one embodiment, the limiting parameter is in the active state when the parameter representative of the set torque is different from the parameter representative of the desired torque.

According to one embodiment, the limiting parameter is in the inactive state when the parameter representative of the set torque is equal to the parameter representative of the desired torque.

The principle of the method according to the invention is, when a limitation of the consumed DC current is necessary, to take into account the deviation of the physical parameters of the motor via the command variable, then, on this basis to determine the value range of the parameter representative of the set torque of the motor making it possible to ensure that the consumed DC current will be equal to or less than the DC current threshold.

The invention may also have one or more of the following features taken alone or in combination.

According to one embodiment, the electric motor is a motor of a power steering of a vehicle.

According to one embodiment, the control parameter has a value of 1 in the active state and 0 in the inactive state.

The control step enables proper operation of the regulation of the measured DC current by activating the regulation step only when necessary.

According to one embodiment, the regulation step is carried out when the control parameter is in the active state.

A divergence of the command variable is thus avoided as long as the measured DC current is less than the DC current threshold.

When the control parameter is in the active state, the parameter representative of the set torque must therefore be as close as possible to the parameter representative of the desired torque while respecting the value range determined by the upper and lower limits.

When the control parameter is in the inactive state, the parameter representative of the set torque is equal to the parameter representative of the desired torque, the upper and lower limits not being taken into account. There is then no regulation of the consumed DC current.

The regulation and determination steps are performed only when the control parameter is in an active state, that is to say when the method regulates or limits the measured DC current to the DC current threshold or as long as the set torque is limited.

According to one embodiment, the evaluation step determines the parameter representative of the set torque as a function of the control parameter.

According to one embodiment, the parameter representative of the set torque and the parameter representative of the desired torque correspond to a torque or to a quadrature axis current.

Thus, the method equally determines a set torque or a set quadrature axis current.

According to one embodiment, the method also comprises a driving step in which the at least one inverter is driven by the microcontroller based on the parameter representative of the set torque.

According to one embodiment, the regulation step determines the command variable by a sum of the DC current threshold and a corrective action value determined by an integral, and/or derivative, and/or proportional type controller receiving as input the DC current threshold and the measured DC current.

The command variable is obtained by the sum of a feedforward corresponding directly to the DC current threshold and a corrective action value resulting from a closed loop control of the proportional, integral, derivative type or a combination thereof. This closed loop corrective action value makes it possible to compensate for both parametric variations, in particular for the flux and the motor resistance whose values change in temperature and production with respect to the reference value implemented in the control, and dynamics in that the lower level loops can generate a certain delay in the control of the requested torque.

According to one embodiment, the upper limit and the lower limit of the parameter representative of the set torque are obtained by solving an equation which is a function of at least: the command variable, a rotational speed of the motor, a voltage of the inverter DC supply current, and a direct axis current of the motor AC supply current measured or determined during a previous iteration.

The equation solved in the determination step is obtained from the general equations of the motor in the direct and quadrature axes.

According to one embodiment, the general equations are as follows:

$${V}_{d} = {R}_{ac} \cdot {I}_{d} + {L}_{d} \cdot \frac{{dI}_{d}}{dt} - p \cdot Ω \cdot {L}_{q} \cdot {I}_{q} \qquad [ Math 1 ]$$

$${V}_{q} = {R}_{ac} \cdot {I}_{q} + {L}_{q} \cdot \frac{{dI}_{q}}{dt} + p \cdot Ω \cdot ( {L}_{d} \cdot {I}_{d} + Ψ ) \qquad [ Math 2 ]$$

$$[ Math 3 ]$$

$${V}_{Dc} \cdot {I}_{Dc} = k \cdot ( {V}_{d} \cdot {I}_{d} + {V}_{q} \cdot {I}_{q} ) = k \cdot ( {R}_{ac} \cdot ( {I}_{d}^{2} + {I}_{q}^{2} ) + p \cdot Ω \cdot {I}_{q} \cdot ( Ψ + ( {L}_{d} - {L}_{q} ) \cdot {I}_{d} ) )$$

$$T = k * p \cdot {I}_{q} \cdot ( Ψ + ( {L}_{d} - {L}_{q} ) \cdot {I}_{d} ) \qquad [ Math 4 ]$$

In which:
V_{DC}: the voltage of the inverter DC supply current (V);
I_{DC}: the inverter average DC supply current (A);
Ψ: an equivalent magnetic flux of the electric motor in a chosen uvw↔dqo transform (Wb);
L_{d}, L_{q}: direct axis and quadrature axis inductances of the electric motor (H);
R_{ac}: a total equivalent resistance on the AC current side of the motor system (Ω);
p: a number of pole pairs of the electric motor;
Ω: a rotational speed of the motor (rade·s⁻¹);
k: the transformation factor in the chosen uvw↔dqo transform (3/2 or 1 for example depending on the chosen convention);
V_{d}, V_{q}: direct axis and quadrature axis voltages of the motor AC supply current (V);
I_{d}, I_{q}: direct axis and quadrature axis currents of the motor AC supply current (A)
T: an electromagnetic torque of the motor (N·m)

According to one embodiment, the equation is a function of physical parameters of the motor.

The physical parameters of the motor are for example a total equivalent resistance on the AC current side, the equivalent magnetic flux, the equivalent resistance, the direct axis and quadrature axis inductances, the number of pole pairs.

These parameters are a consequence of the dimensioning of the motor. They are assumed to be constant when solving the equations and fixed reference values are used for simplicity.

The transformation factor in a chosen uvw↔dqo transform is a fixed gain corresponding to a chosen convention.

According to one embodiment, the method comprises a calculation step in which a transformation gain is determined as a function of the transformation factor in a uvw↔dqo transform, a number of pole pairs of the motor, an equivalent magnetic flux of the motor in the uvw↔dqo transform, the direct axis current of the motor AC supply current measured or determined during the previous iteration and direct axis and quadrature axis inductances of the motor.

According to one embodiment, the transformation gain is calculated by the formula:

$${G}_{Iq 2 Trq} = k \cdot p \cdot ( ψ + ( {L}_{d} - {L}_{q} ) \cdot {I}_{d} ) \qquad [ Math 5 ]$$

With:
G_{Iq2Trq}: the transformation gain;
k: the transformation factor in the chosen uvw↔dqo transform (3/2 or 1 for example depending on the chosen convention);
p: a number of pole pairs of the electric motor;
Ψ: an equivalent magnetic flux of the electric motor in a chosen uvw↔dqo transform (Wb);
L_{d}, L_{q}: direct axis and quadrature axis inductances of the electric motor (H);
I_{d}: the direct axis current of the motor AC supply current (A);

According to one embodiment, the upper limit and the lower limit of the parameter representative of the set torque are obtained by solving the equation below:

$$k \cdot {R}_{ac} \cdot {I}_{qLim}^{2} + {G}_{Iq 2 Trq} \cdot Ω \cdot {I}_{qLim} + k \cdot {R}_{a c} \cdot {I}_{d}^{2} - {V}_{Dc} \cdot {I}_{DCCom} = 0 \qquad [ Math 6 ]$$

With:
k: the transformation factor in the chosen uvw↔dqo transform (3/2 or 1 for example depending on the chosen convention);
R_{ac}: a total equivalent resistance on the AC current side of the motor system (Ω);
G_{Iq2Trq}: the transformation gain;
Ω: a rotational speed of the motor (rad·s⁻¹);
I_{d}: the direct axis current of the motor AC supply current (A);
V_{DC}: the voltage of the inverter DC supply current (V);
I_{DCCom}: the command variable (A),
I_{qLim}: the quadrature axis current limit of the motor AC supply current (A);

We obtain that:

$${I}_{qLimMax} = \frac{- B + \sqrt{Δ}}{2 \cdot A} ↔ {T}_{LimMax} = {G}_{Iq 2 Trq} \cdot {I}_{qLimMax} \qquad [ Math 7 ]$$

$$And$$

$${I}_{qLimMin} = \frac{- B - \sqrt{Δ}}{2 \cdot A} ↔ {T}_{LimMin} = {G}_{Iq 2 Trq} \cdot {I}_{qLimMin} \qquad [ Math 8 ]$$

$$With$$

$$A = k \cdot {R}_{a c} \qquad [ Math 9 ]$$

$$B = {G}_{Iq 2 Trq} \cdot Ω \qquad [ Math 10 ]$$

$$C = k \cdot {R}_{a c} \cdot {I}_{d}^{2} - {V}_{DC} \cdot {I}_{DCCom} \qquad [ Math 11 ]$$

$$Δ = {B}^{2} - 4 \cdot A \cdot C \qquad [ Math 12 ]$$

In which:
k: the transformation factor in the chosen uvw↔dqo transform (3/2 or 1 for example depending on the chosen convention);
R_{ac}: a total equivalent resistance on the AC current side of the motor system (Ω);
G_{Iq2Trq}: the transformation gain;
Ω: a rotational speed of the motor (rad·s⁻¹);
I_{d}: the direct axis current of the motor AC supply current (A);
V_{DC}: the voltage of the inverter DC supply current (V);
I_{DCCom}: the command variable (A),
I_{qLimMin}: the lower limit of the quadrature axis current of the motor AC supply current (A);
I_{qLimMax}: the upper limit of the quadrature axis current of the motor AC supply current (A);
T_{LimMax}: the upper limit of the set torque (N·m);
T_{LimMin}: the lower limit of the set torque (N·m).

According to one embodiment, the control parameter is passed into an active state when the measured DC current is greater than or equal to the DC current threshold, and passed into an inactive state when the measured DC current is less than the DC current threshold and that the parameter representative of the set torque is equal to the parameter representative of the desired torque.

Thus, the limitation carried out by the method is effective when the measured DC current is greater than or equal to the DC current threshold and stopped when the measured DC current becomes less than the DC current threshold and the method no longer applies limitation.

According to one embodiment, the control parameter is initiated in the inactive state.

By default, no limitation is performed on the parameter representative of the set torque. It is only when the DC current threshold is observed to be exceeded that the limitation is implemented.

The invention also relates to a power steering system comprising at least one motor controlled by the method according to the invention.

The invention will be better understood, thanks to the description below, which relates to an embodiment according to the present invention, given as a non-limiting example and explained with reference to the appended schematic drawings, in which:

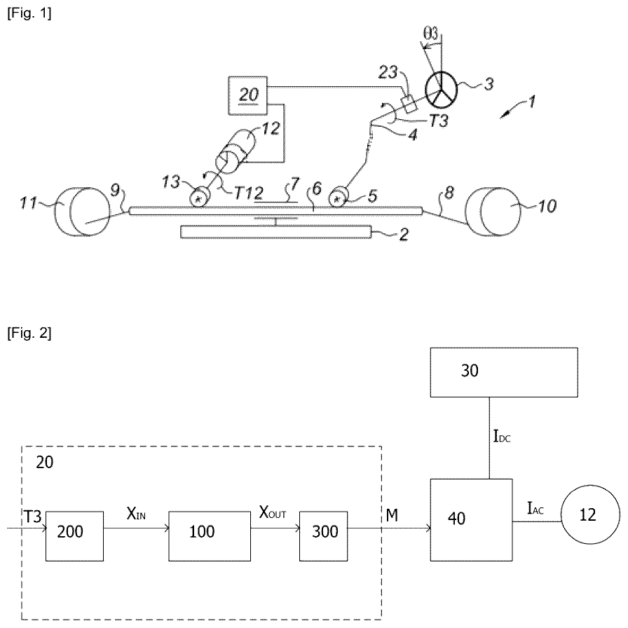

FIG. 1 is a schematic representation of a power steering system comprising a method according to the invention;

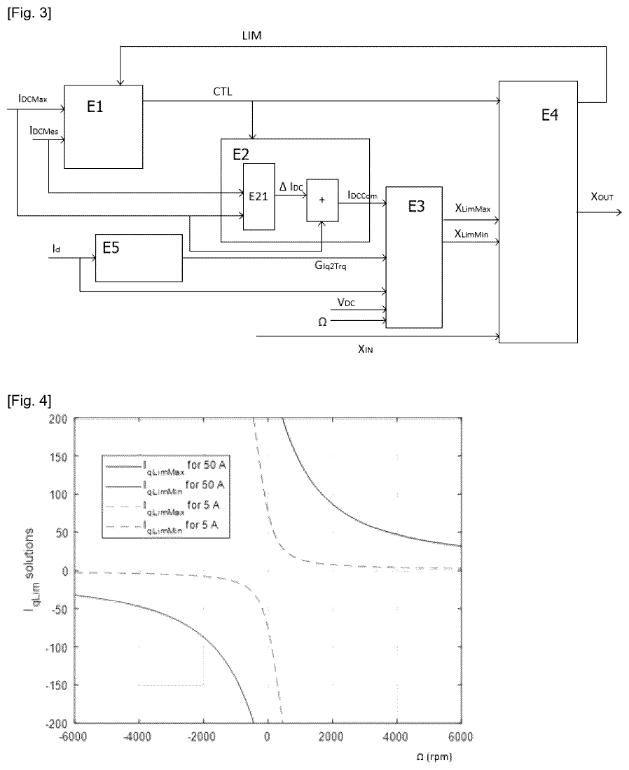

FIG. 2 is a block diagram of a power supply of a motor;

FIG. 3 is a diagram of the method according to the invention;

FIG. 4 is a representation of the upper and lower limits of the parameter representative of the set torque as a function of a rotational speed of a motor;

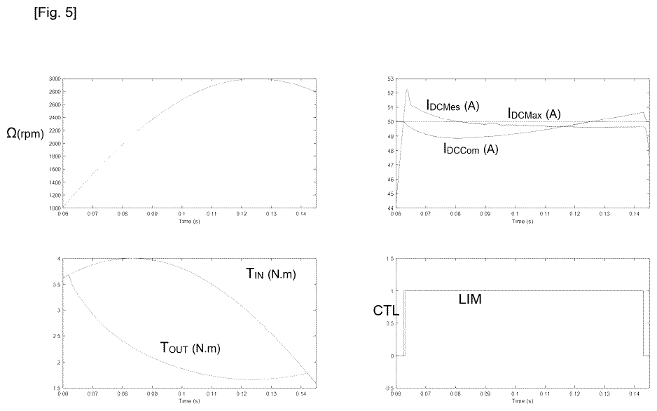

FIG. 5 is a temporal simulation of the rotational speed of the motor, a parameter representative of a desired and set torque, a measured DC current, a DC current threshold, a command variable, a limiting parameter and a control parameter.

A steering system 1 of a vehicle 2, as illustrated in FIG. 1, aims to allow a driver to control a vehicle 2 path by modifying an angle of orientation of the vehicle's wheels 10, 11 by means of a steering wheel 3. The angle of orientation of the wheels is in particular related to an angle 63 of the steering wheel 3. The driver modifies the angle 63 of the steering wheel 3 by exerting a force T3 on the steering wheel 3, hereinafter called “steering wheel torque”. The force T3 exerted on the steering wheel can be measured by means of a torque sensor 23.

Generally, a steering system 1 comprises several elements including said steering wheel 3, a rack 6, and two wheels 10, 11 each connected to a tie rod 8, 9. The rack 6 is the part allowing the wheels 10, 11 to be maneuvered, that is to say making it possible to modify the angle of orientation of the wheels 10, 11, via the tie rods 8, 9. The rack 6 transforms a variation in the angle of the steering wheel 3 into a variation of the angle of orientation of the vehicle's wheels 10, 11.

An electric power steering system 1 comprises a power supply system of the motor 12 as illustrated in FIG. 2. The power supply system comprises at least one microcontroller 20 which determines in particular via a high-level controller 200 a parameter representative of the desired torque X_{IN} based on the force T3 exerted on the steering wheel 3 in a manner known to those skilled in the art. The parameter representative of the desired torque X_{IN} is the torque that the user wants the motor 12 to exert independently of the consumed DC current I_{DC}.

Then the method 100 according to the invention determines based on the parameter representative of the desired torque X_{IN} the parameter representative of the set torque X_{OUT} to be applied by an electric motor 12.

The parameter representative of the set torque X_{OUT} is transformed into variables M, by a modulation unit 300, making it possible to drive an inverter 40 by a vector control method.

The inverter 40 is electrically supplied with a DC current I_{DC} which it transforms into an AC current I_{AC} supplied to the motor 12. The motor AC supply current I_{AC} comprises a direct axis component, hereinafter designated by direct axis current I_{d}, and a quadrature axis component, hereinafter designated by quadrature axis current.

The DC current I_{DC}, having a supply voltage V_{DC}, is provided by a DC supply system 30, or DC system, which may be a battery or a DC-DC converter for example.

The motor 12 exerts a motor torque T12 on the rack 6 on the basis of the parameter representative of the set torque X_{OUT}. The motor torque T12 depends on the AC current I_{AC} supplied to the motor 12. A user of the motor 12 seeks to ensure that the motor torque T12 is close to or equal to the desired torque defined by the parameter representative of the desired torque X_{IN}.

Hereinafter called motor system, all the elements making it possible to control the electric motor 12. The motor system includes in particular the motor-inverter assembly, and the microcontroller 20.

The electric motor 12 is preferably an electric motor, with two directions of operation, and preferably a rotary electric motor, of the brushless type.

The invention applies for example to an electric motor 12 of a mechanical type power steering, that is to say in which there is a mechanical link generally performed by a steering column 4 which meshes, by means of a steering pinion 5, with the rack 6, which is itself guided in translation in a casing 7 fastened to the vehicle 2, or an electric power steering system without mechanical link, called “steer-by-wire”, in which the steering wheel is mechanically detached from the rack, not illustrated in the figures.

In the case of mechanical type power steering, the electric motor 12 can engage through a gear reduction type reducer, or on the steering column 4 itself, to form a so-called “single pinion” mechanism, or directly on the steering rack 6, by means for example of a second pinion 13 distinct from the steering pinion 5 which allows the steering column 4 to mesh with the rack 6, so as to form a so-called “double pinion” mechanism, as illustrated in FIG. 1.

The invention relates more particularly to a method for controlling an electric motor 12 of the synchronous type which can be an electric motor 12 of the steering system as represented in FIG. 1 or of another application.

The method 100 according to the invention is represented in FIG. 3.

The method 100 according to the invention determines the parameter representative of the set torque X_{OUT} which can be a torque or a quadrature axis current. Likewise, the parameter representative of the desired torque X_{IN} corresponds to a torque or a quadrature axis current.

The method 100 comprises a control step E1. This step E1 receives as input a DC current threshold I_{DCMax}, a measured DC current I_{DCMes} and determines a control parameter CTL.

The control step E1 also receives as input a limitation parameter LIM.

The DC current threshold I_{DCMax} is the maximum value of consumed DC current I_{DC} that we wish not to exceed. In other words, during operation of the motor 12, the DC current threshold I_{DCMax} corresponds to the regulation value of the DC current I_{DC}. The DC current threshold I_{DCMax} is determined by a user.

The measured DC current I_{DCMes} corresponds to the value of the DC current I_{DC} actually consumed by the motor 12 during a previous iteration. The method 100 according to the invention regulates the measured DC current I_{DCMes} so as to keep it less than or equal to the DC current threshold I_{DCMax}.

During the control step E1, the microcontroller 20 activates or deactivates a performance of the regulation of the DC current I_{DC} actually consumed. In other words, it allows implementation of the method 100 according to the invention. For this, the control parameter CTL is passed into an active state ON or an inactive state OFF as a function of the DC current threshold I_{DCMax} and the measured DC current I_{DCMes}, and the limitation parameter LIM.

According to one embodiment, the control parameter CTL has a value of 1 in the active state ON and 0 in the inactive state OFF.

According to one embodiment, the control parameter CTL is initiated in the inactive state OFF, that is to say:

$$CTL = OFF \qquad [ Math 13 ]$$

According to one embodiment, the control parameter CTL is passed into the active state ON when the measured DC current I_{DCMes} is greater than or equal to the DC current threshold I_{DCMax}, and passed into the inactive state OFF when the measured DC current I_{DCMes} is less than the DC current threshold I_{DCMax} and the limitation parameter LIM is in an inactive state OFF.

In other words:

$$If {I}_{DCMes} \geq {I}_{DCMax} \text{=>} CTL = ON \qquad [ Math 14 ]$$

$$If {I}_{DCMes} < {I}_{DCMax} \qquad [ Math 15 ]$$

$$AND$$

$$LIM = OFF \text{=>} CTL = OFF$$

The limitation of the method 100 is effective when the measured DC current I_{DCMes} is greater than or equal to the DC current threshold I_{DCMax} and stopped when the measured DC current I_{DCMes} becomes less than the DC current threshold I_{DCMax} and the method 100 does not preform no more limitations. In other words, by default, no limitation is performed on the parameter representative of the set torque X_{OUT}. It is only when the DC current threshold I_{DCMax} is exceeded that the limitation is implemented.

The control step allows proper operation of the regulation of the measured DC current I_{DCMes} by activating the latter only when necessary.

The method 100 comprises a regulation step E2. During this step, a command variable I_{DCCom} is determined as a function of the DC current threshold I_{DCMax} and the measured DC current I_{DCMes}.

The command variable I_{DCCom} corresponds to a command virtual DC current making it possible to maintain the maximum value of consumed DC current less than or equal to the DC current threshold I_{DCMaX}.

The regulation step makes it possible to compensate on the one hand for parametric variations, in particular for the flux and the motor resistance whose values change as a function of the temperature and in production with respect to a reference value implemented in the control, and on the other hand dynamics in that lower level regulation loops can generate a certain delay in controlling the desired torque.

According to one embodiment, the regulation step E2 is carried out when the control parameter CTL is in the active state ON.

A divergence of the command variable I_{DCCom} is thus avoided as long as the measured DC current I_{DCMes} is less than the DC current threshold I_{DCMax}.

The regulation step E2 determines the command variable I_{DCCom} by a sum of the DC current threshold I_{DCMax} and a corrective action value ΔI_{DC} determined by a controller E21 of integral, and/or derivative, and/or proportional type receiving as input the DC current threshold I_{DCMax} and the measured DC current I_{DCMes}.

The method 100 comprises a determination step E3. During this step, an upper limit X_{LimMax} and a lower limit X_{LimMin} of the parameter representative of the set torque X_{OUT} are determined at least as a function of the command variable I_{DCCom}. The determination step E3 is therefore successive to the regulation step E2 and they are only performed when the control parameter CTL is in an active state ON, that is to say when the method 100 regulates or limits the measured DC current I_{DCMes} to the value of the DC current threshold I_{DCMax}. In other words, the regulation E2 and determination E3 steps are carried out only when the measured DC current I_{DCMes} must be less than or equal to the DC current threshold I_{DCMax} or as long as the set torque X_{OUT} is limited.

The upper limit X_{LimMax} and the lower limit X_{LimMin} define a value range in which must be the parameter representative of the set torque X_{OUT} to ensure that the measured DC current I_{DCMes} or consumed by the motor 12 remains less than or equal to the DC current threshold I_{DCMax}. The dispersion of the physical parameters of the motor system 12 being taken into account by the command variable I_{DCCom}, this step E3 does not implement calculations or adjustment of complex variables.

According to one embodiment, the upper limit X_{LimMax} and the lower limit X_{LimMin} of the parameter representative of the set torque X_{OUT} are obtained by solving an equation which is a function of at least: the command variable I_{DCCom}, a rotational speed Ω of the motor 12, a voltage of the DC current V_{DC} supplied to the inverter 40, and a direct axis current I_{d} of the AC current I_{AC} supplied to the motor 12 measured or determined during a previous iteration.

According to one embodiment, the equation is a function of physical parameters of the motor.

The physical parameters of the motor are for example a total equivalent resistance on the AC current side, the equivalent magnetic flux, the equivalent resistance, the direct axis or quadrature axis inductances, the number of pole pairs.

These parameters are a consequence of the dimensioning of the motor. They are assumed to be constant in the resolution of the equations and fixed reference values are used for simplicity.

The transformation factor in a chosen uvw↔dqo transform is a fixed gain corresponding to a chosen convention.

The transformation gain G_{Iq2Trq} is determined during a calculation step E5 as a function of the transformation factor k in a uvw↔dqo transform, a number of pole pairs p of the motor 12, an equivalent magnetic flux 4P of the motor in the uvw↔dqo transform, the direct axis current I_{d} of the AC current I_{AC} supplied to the motor 12 measured or determined during the previous iteration and the direct axis L_{d} and quadrature axis L_{q} inductances of the motor 12.

According to one embodiment, the transformation gain is calculated by the formula:

$${G}_{Iq 2 Trq} = k \cdot p \cdot ( ψ + ( {L}_{d} - {L}_{q} ) \cdot {I}_{d} ) \qquad [ Math 16 ]$$

With:
G_{Iq2Trq}: the transformation gain;
k: transformation factor in the chosen uvw↔dqo transform (3/2 or 1 for example depending on the chosen convention);
p: a number of pole pairs of the electric motor;
Ψ: an equivalent magnetic flux of the electric motor in a chosen uvw↔dqo transform (Wb);
L_{d}, L_{q}: direct axis and quadrature axis inductances of the electric motor (H);
I_{d}: the direct axis current of the motor supply AC current (A)

The equation solved during the determination step E3 is obtained from the general equations of the motor 12 in the direct and quadrature axes.

According to one embodiment, the general equations are as follows:

$${V}_{d} = {R}_{ac} \cdot {I}_{d} + {L}_{d} \cdot \frac{{dI}_{d}}{dt} - p \cdot Ω \cdot {L}_{q} \cdot {I}_{q} \qquad [ Math 17 ]$$

$${V}_{q} = {R}_{ac} \cdot {I}_{q} + {L}_{q} \cdot \frac{{dI}_{q}}{dt} + p \cdot Ω \cdot ( {L}_{d} \cdot {I}_{d} + Ψ ) \qquad [ Math 18 ]$$

$$[ Math 19 ]$$

$${V}_{Dc} \cdot {I}_{Dc} = k \cdot ( {V}_{d} \cdot {I}_{d} + {V}_{q} \cdot {I}_{q} ) = k \cdot ( {R}_{ac} \cdot ( {I}_{d}^{2} + {I}_{q}^{2} ) + p \cdot Ω \cdot {I}_{q} \cdot ( Ψ + ( {L}_{d} - {L}_{q} ) \cdot {I}_{d} ) )$$

$$T = k * p \cdot {I}_{q} \cdot ( Ψ + ( {L}_{d} - {L}_{q} ) \cdot {I}_{d} ) \qquad [ Math 20 ]$$

In which:
V_{DC}: the voltage of the inverter supply DC current (V);
I_{DC}: the average inverter supply DC current (A);
Ψ: an equivalent magnetic flux of the electric motor in a chosen uvw↔dqo transform (Wb);
L_{d}, L_{q}: direct axis and quadrature axis inductances of the electric motor (H);
R_{ac}: a total equivalent resistance on the AC current side of the motor system (Ω);
p: a number of pole pairs of the electric motor;
Ω: a rotational speed of the motor (rad·s¹);
k: transformation factor in the chosen uvw↔dqo transform (3/2 or 1 for example depending on the chosen convention);
V_{d}, V_{q}: direct axis and quadrature axis voltages of the motor supply AC current (V);
I_{d}, Iq: direct axis and quadrature axis currents of the motor supply AC current (A)
T: electromagnetic torque of the motor (Nm)

According to one embodiment, the upper limit X_{LimMax} and the lower limit X_{LimMin} of the parameter representative of the set torque X_{OUT} are obtained by solving the

$$k \cdot {R}_{a c} \cdot {I}_{qLim}^{2} + {G}_{Iq 2 Trq} \cdot Ω \cdot {I}_{qLim} + k \cdot {R}_{a c} \cdot {I}_{d}^{2} - {V}_{Dc} \cdot {I}_{DCCom} = 0 \qquad [ Math 21 ]$$

With:
k: transformation factor in the chosen uvw↔dqo transform (3/2 or 1 for example depending on the chosen convention);
R_{ac}: a total equivalent resistance on the AC current side of the motor system (Ω);
G_{Iq2Trq}: the transformation gain;
Ω: a rotational speed of the motor (rad·s⁻¹);
I_{d}: the direct axis current of the motor supply AC current (A);
V_{DC}: the voltage of the inverter supply DC current (V);
I_{DCCom}: the command variable (A),
I_{qLim}: the limit of the quadrature axis current of the motor supply AC current (A);

We obtain that:

$${I}_{qLimMax} = \frac{- B + \sqrt{Δ}}{2 \cdot A} ↔ {T}_{LimMax} = {G}_{Iq 2 Trq} \cdot {I}_{qLimMax} \qquad [ Math 22 ]$$

$$And$$

$${I}_{qLimMin} = \frac{- B - \sqrt{Δ}}{2 \cdot A} ↔ {T}_{LimMin} = {G}_{Iq 2 Trq} \cdot {I}_{qLimMin} \qquad [ Math 23 ]$$

$$With$$

$$A = k \cdot {R}_{a c} \qquad [ Math 24 ]$$

$$B = {G}_{Iq 2 Trq} \cdot Ω \qquad [ Math 25 ]$$

$$C = k \cdot {R}_{a c} \cdot {I}_{d}^{2} - {V}_{DC} \cdot {I}_{DCCom} \qquad [ Math 26 ]$$

$$Δ = {B}^{2} - 4 \cdot A \cdot C \qquad [ Math 27 ]$$

In which:
k: transformation factor in the chosen uvw↔dqo transform (3/2 or 1 for example depending on the chosen convention);
R_{ac}: a total equivalent resistance on the AC current side of the motor system (Ω);
G_{Iq2Trq}: the transformation gain;
Ω: a rotational speed of the motor (rad·s⁻¹);
I_{d}: the direct axis current of the motor supply AC current (A);
V_{DC}: the voltage of the inverter supply DC current (V);
I_{DCCom}: the command variable (A),
I_{qLimMin}: the lower limit of the quadrature axis current of the motor supply AC current (A);
I_{qLimMax}: the upper limit of the quadrature axis current of the motor supply AC current (A);
T_{LimMax}: the upper limit of the set torque (N·m);
T_{LimMin}: the lower limit of the set torque (N·m).

The method finally comprises an evaluation step E4. During this step, the parameter representative of the set torque X_{OUT} is determined at least as a function of the upper limit X_{LimMax} and the lower limit X_{LimMin} of the parameter representative of the set torque X_{OUT}, the control parameter CTL and the parameter representative of the desired torque X_{IN}.

When the control parameter CTL is in the active state ON, the parameter representative of the set torque X_{OUT} must therefore be as close as possible to the parameter representative of the desired torque X_{IN} while respecting the value range determined by the upper X_{LimMax} and lower X_{LimMin} limits. In other words:

$$If CTL = ON \text{=>} {X}_{OUT} = min ( {X}_{LimMax} , max ( {X}_{LimMin} , {X}_{IN} ) ) \qquad [ Math 28 ]$$

When the control parameter CTL is in the inactive state OFF, the parameter representative of the set torque X_{OUT} is equal to the parameter representative of the desired torque X_{IN}, the upper X_{LimMax} and lower X_{LimMin} limits not being taken into account. There is then no regulation of the consumed DC current I_{DC}. In other words:

$$If CTL = OFF \text{=>} {X}_{OUT} = {X}_{IN} \qquad [ Math 29 ]$$

According to one embodiment, the evaluation step E4 determines the limitation parameter LIM at least as a function of the parameter representative of the set torque X_{OUT} and the parameter representative of the desired torque X_{IN}.

The limitation parameter LIM indicates whether a limitation of the parameter representative of the desired torque X_{IN} was carried out during the evaluation step E4.

According to one embodiment, the limitation parameter LIM is in the active state ON when the parameter representative of the set torque X_{OUT} is different from the parameter representative of the desired torque X_{IN}. In other words:

$$If {X}_{OUT} \neq {X}_{IN} \text{=>} LIM = ON \qquad [ Math 30 ]$$

According to one embodiment, the limitation parameter LIM is in the inactive state OFF when the parameter representative of the set torque X_{OUT} is equal to the parameter representative of the desired torque X_{IN}. In other words:

$$If {X}_{OUT} = {X}_{IN} \text{=>} LIM = OFF \qquad [ Math 31 ]$$

Finally, the method comprises a driving step in which the inverter 40 is driven by the microcontroller 20 on the basis of the parameter representative of the set torque X_{OUT}.

The principle of the method 100 according to the invention is, when a limitation of the consumed DC current I_{DC} is necessary, to take into account the deviation of the physical parameters of the motor 12 via the command variable I_{DCCom}, then, on this basis to determine the value range of the parameter representative of the set torque X_{OUT} of the motor 12 making it possible to ensure that the consumed DC current I_{DC} will be equal to or less than the DC current threshold I_{DCMax}.

FIG. 4 illustrates the solutions I_{qLimMax}, I_{qLimMin} of the equation solved during the determination step as a function of the rotational speed Ω of the motor 12 for a DC current threshold of 50A and 5A.

FIG. 5 illustrates a temporal simulation of the rotational speed Ω of the motor 12, of the parameter representative of a desired T_{IN} and set T_{OUT} torques expressed in the form of a torque, of the measured DC current I_{DCMes}, the DC current threshold I_{DCMax}, the command variable I_{DCCom}, the limitation parameter LIM and the control parameter CTL.

The limitation parameter LIM and the control parameter CTL are initially in the inactive state OFF, that is to say at a value of 0. The DC current threshold I_{DCMax} is set to 50 A.

When the rotational speed Ω of the motor 12 increases and the desired torque T_{IN} increases, the measured DC current I_{DCMes} increases then exceeds the DC current threshold I_{DCMax}. This overrun successively leads to the passage into the active state ON, that is to say to a value of 1 of the control parameter CTL, then a calculation of the command variable I_{DCCom} which is less than 50A and finally a set torque T_{OUT} which decreases and a passage into the active state ON, that is to say to a value of 1, of the limitation parameter LIM. As a result, the measured DC current I_{DCMes} decreases until it returns around the DC current threshold I_{DCMax}, which is the regulation setpoint.

With the drop in the rotational speed Ω of the motor 12 naturally generating a widening of the upper TLimMax and lower TLimMin limits, of the parameter representative of the set torque, combined in this example with a drop in the desired torque TIN, the limitation parameter LIM returns to the inactive state OFF. The measured DC current IDCMes having logically returned below the DC current threshold IDCMax, the control parameter CTL has also passed into the inactive state OFF. The desired torque TIN again becomes equal to the set torque TOUT.

Of course, the invention is not limited to the embodiments described and represented in the appended figures. Modifications remain possible, particularly from the point of view of the constitution of the various elements or by substitution of technical equivalents, without departing from the scope of protection of the invention.

1-9. (canceled)

10. A method for determining a parameter representative of a set torque for a motor, the motor being supplied with an AC current coming from at least one inverter, the at least one inverter being driven by at least one microcontroller using a vector control method, the at least one inverter being supplied with a DC current coming from at least one DC current supply system, the method being executed by the at least one microcontroller and comprising:
a control step in which a control parameter is determined at least as a function of a DC current threshold, a measured DC current and a limitation parameter;
a regulation step in which a command variable is determined at least as a function of the DC current threshold and the measured DC current;
a determination step in which an upper limit and a lower limit of the parameter representative of the set torque are determined at least as a function of the command variable;
an evaluation step in which the parameter representative of the set torque is determined at least as a function of the upper limit and the lower limit of the parameter representative of the set torque and a parameter representative of the desired torque.

11. The determination method according to claim 10, wherein the parameter representative of the set torque and the parameter representative of the desired torque correspond to a torque or to a current quadrature axis.

12. The determination method according to claim 10, also comprising a driving step in which the at least one inverter is driven by the microcontroller on the basis of the parameter representative of the set torque.

13. The determination method according to claim 10, wherein the regulation step determines the command variable by a sum of the DC current threshold and a corrective action value determined by a controller of integral, and/or derivative, and/or proportional type receiving as input the DC current threshold and the measured DC current.

14. The determination method according to claim 10, wherein the upper limit and the lower limit of the parameter representative of the set torque are obtained by a resolution of a equation which is a function of at least: the command variable, a rotational speed of the motor, a DC current voltage supplied to the inverter, and a direct axis current of the motor supply AC current measured or determined during a previous iteration.

15. The determination method according to claim 14, comprising a calculation step in which a transformation gain is determined as a function of the transformation factor in a uvw↔dqo transform, a number of pole pairs of the motor, an equivalent magnetic flux of the motor in the uvw↔dqo transform, the direct axis current of the motor supply AC current measured or determined during the previous iteration and direct axis or quadrature axis inductances of the motor.

16. The determination method according to claim 10, wherein the control parameter is passed into an active state when the measured DC current is greater than or equal to the DC current threshold, and passed into an inactive state when the measured DC current is less than the DC current threshold and the parameter representative of the set torque is equal to the parameter representative of the desired torque.

17. The determination method according to claim 16, wherein the control parameter is initiated in the inactive state.

18. A power steering system comprising at least one motor controlled by the parameter representative of a set torque determined by the method according to claim 10,
